(19) United States
(12) Patent Application Publication
(10) Pub. No.: US 2011/0265769 A1
(43) Pub. Date: Nov. 3, 2011

(54) Fuel Warming System

(76) Inventors: Russell C. Crowther, New Market (CA); Charles R. Crowther, East Montpelier, VT (US)

(21) Appl. No.: 13/171,936

(22) Filed: Jun. 29, 2011

Related U.S. Application Data
(63) Continuation-in-part of application No. 12/703,338, filed on Feb. 10, 2010.

(51) Int. Cl. F02G 5/00

(52) U.S. Cl. 123/557

(57) ABSTRACT

A fuel warming system featuring an outer housing that houses an inner housing, wherein a double copper coil is wrapped around the inner housing. Heating fluid and a heating element is disposed in the inner housing. A first thermal disc is adjustable and allows the temperature of the coil to be adjusted. A second thermal disc functions as a safety device for ensuring the coil does not reach a maximum temperature. Fuel that enters the metal coil is warmed by the heat transferred from the heating fluid and heating element.

### CROSS REFERENCE

This application is a continuation-in-part of U.S. patent application Ser. No. 12/703,338 filed Feb. 10, 2010, the disclosure of which is incorporated herein by reference in its entirety.

### FIELD OF THE INVENTION

The present invention is directed to a system for warming fuel before it is combusted inside a vehicle engine.

### BACKGROUND OF THE INVENTION

Numerous types of fuel warming systems for vehicles are currently in use. Fuel warming systems warm fuel before it is injected into an engine. The present invention features an improved fuel warming system, which may be used with unleaded fuel or diesel fuel.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

The present invention features a fuel warming system for increasing the temperature of fuel for an engine of a vehicle. In some embodiments, the system comprises an outer housing having a first end, a second end, and an inner cavity; an inner housing disposed in the inner cavity of the outer housing, the inner housing having a first end, a second end, and an inner cavity; a heating fluid filling the inner cavity of the inner housing; a heating element disposed in the inner cavity of the inner housing, the heating element functions to increase a temperature of the heating fluid; a metal coil disposed in the inner cavity of the outer housing and coiled around the inner housing and contacting the inner housing, the metal coil has a first end fluidly connected to a first fuel line and a second end fluidly connected to a second fuel line, wherein fuel enters the metal coil via the first end and exits the metal coil via the second end, when the heating element is activated heat transfers from the heating element to the heating fluid to the metal coil to the fuel within the coil; and a first thermal disc functioning to detect a temperature of the metal coil via a first sensor, the first sensor directly contacts the metal coil, when the first thermal disc is activated the first thermal disc causes activation of the heating element to a pre-set temperature, the pre-set temperature is adjustable.

In some embodiments, the system further comprises a second thermal disc operatively connected to the metal coil. The second thermal disc is programmed with a maximum temperature wherein if the second thermal disc detects the maximum temperature, the second thermal disc causes the system to shut off. In some embodiments, the maximum temperature is about 130° F. In some embodiments, the maximum temperature is about 125° F. In some embodiments, the maximum temperature is about 120° F.

In some embodiments, the system further comprises insulation disposed in the inner cavity of the outer housing, the insulation surrounds the inner housing and the metal coil. In some embodiments, the metal coil is a double coil. In some embodiments, the metal coil is constructed from a material comprising copper.

In some embodiments, the first fuel line extends outwardly through the first end of the outer housing. In some embodiments, the first fuel line extends outwardly through the second end of the outer housing. In some embodiments, the second fuel line extends outwardly through the first end of the outer housing. In some embodiments, the second fuel line extends outwardly through the second end of the outer housing.

In some embodiments, the first fuel line extends outwardly through the first end of the outer housing and the second fuel line extends outwardly through the first end of the outer housing. In some embodiments, the first fuel line extends outwardly through the second end of the outer housing and the second fuel line extends outwardly through the second end of the outer housing. In some embodiments, the first fuel line extends outwardly through the first end of the outer housing and the second fuel line extends outwardly through the second end of the outer housing. In some embodiments, the first fuel line extends outwardly through the second end of the outer housing and the second fuel line extends outwardly through the first end of the outer housing.

### BRIEF DESCRIPTION OF THE DRAWINGS

FIG. 1 is a perspective view of the fuel warming system of the present invention.

FIG. 2 is a side view of the system of the present invention.

FIG. 3 is a first side cross sectional view of the system of FIG. 1.

FIG. 4 is a second side cross sectional view of the system of FIG. 2.

FIG. 5 is a side view of the metal coil of the system of the present invention.

FIG. 6 is an in-use view of the system of the present invention.

### DESCRIPTION OF PREFERRED EMBODIMENTS

A gallon of fuel is typically measured at 60° F. When the temperature of the fuel changes, its density changes. For example, fuel may experience a 0.5% change in density with a 9° F. temperature change. The change in density of the fuel can alter how much fuel is actually used (e.g., the exact number of molecules fed to the combustion chamber of the engine). For example, fuel experiences an increase in density when the temperature drops (e.g., more molecules per volume of fuel); thus, more fuel molecules are fed to the engine in a given volume. This decreases fuel efficiency and wastes fuel.

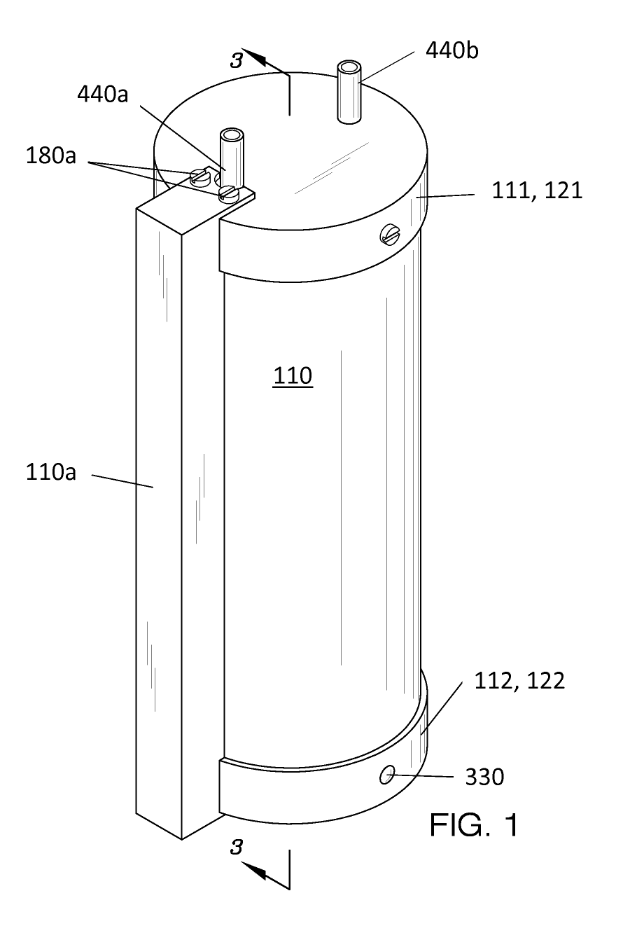

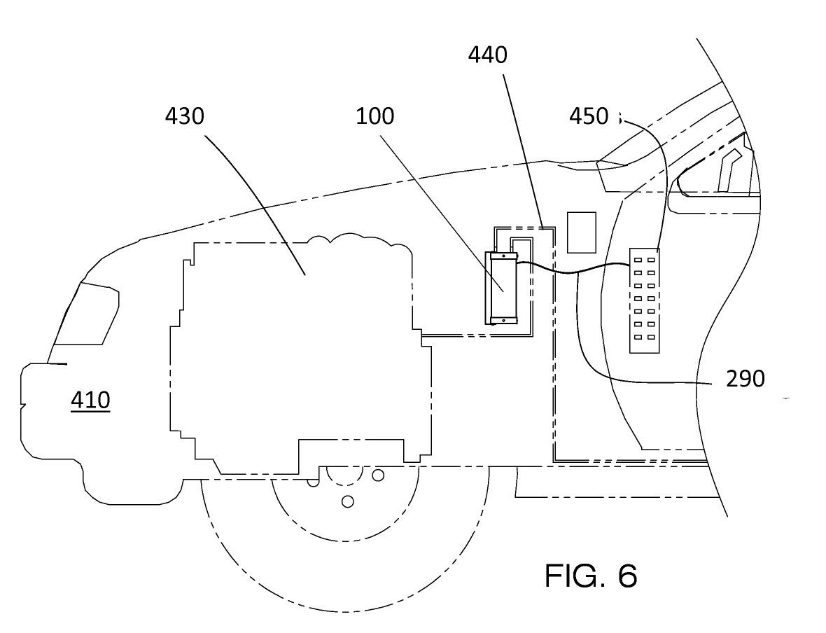

Referring now to FIG. 1-6, the present invention features a fuel warming system 100 for increasing the temperature of fuel for an engine 430 of a vehicle 410. The system 100 helps prevent wasting of fuel that can occur when the temperature drops. The fuel warming system 100 can be used with diesel fuel or unleaded fuel. In some embodiments, the system 100 is installed on or near the intake manifold fuel supply.

The system 100 comprises an outer housing 110 having a first end 111, a second end 112, an outside surface 113, and an inner cavity 114. The outer housing 110 may be constructed in a variety of shapes including but not limited to a cylindrical shape. In some embodiments, the first end 111 of the outer housing 110 is a first plate 121 and the second end 112 of the outer housing 110 is a second plate 122. The plates 121, 122 may be removably attached to the ends 111, 112 of the outer housing 110, respectively.

An inner housing 210 is disposed in the inner cavity 114 of the outer housing 110. The inner housing 210 has a first end 211, a second end 212, an outside surface, and an inner cavity 214. Disposed in the inner cavity 214 of the inner housing 210 is a heating fluid 220 (e.g., oil). The heating fluid 220 fills the inner cavity 214 of the inner housing 210. In some embodiments, the heating fluid 220 comprises a material such as an anti-freeze, a thermal transfer oil, the like, or a combination thereof. Such heating fluids are well known to one of ordinary skill in the art.

A heating element 250 is disposed in the inner cavity 214 of the inner housing 210. The heating element 250 functions to increase a temperature of the heating fluid 220 in the inner cavity 214 of the inner housing 210. In some embodiments, the heating element 250 is a 12-volt submersible heater or the like; however, the heating element 250 is not limited to a 12-volt submersible heater. In some embodiments, the heating element 250 extends from the first end 211 of the inner housing 210 to near the second end 212 of the inner housing 210.

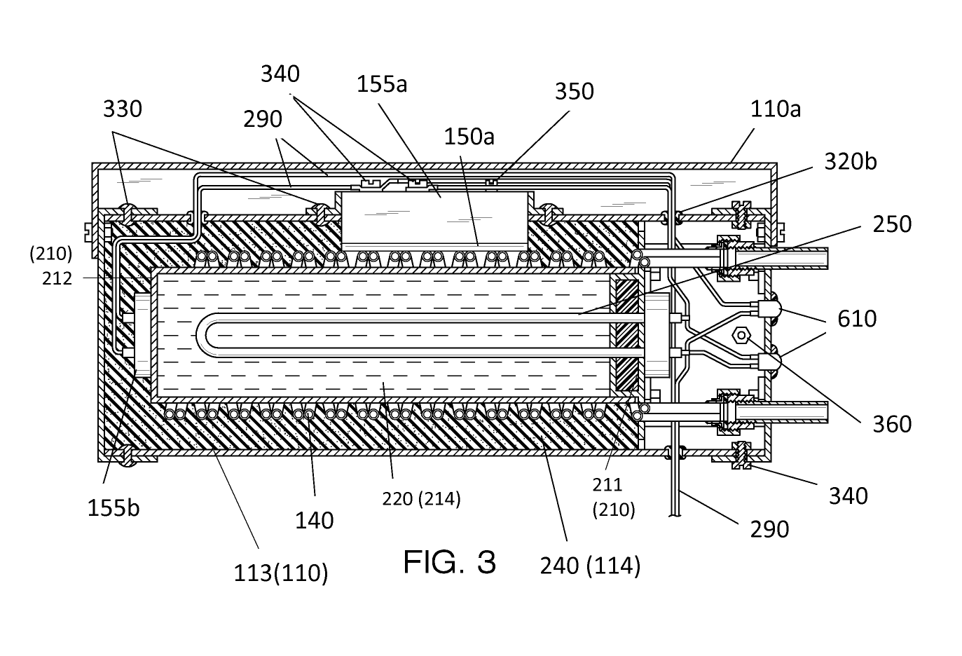

A metal coil 140 is disposed in the inner cavity 114 of the outer housing 110 and surrounds the inner housing 210 (e.g., the metal coil 140 is external to the heating components, e.g., the heating element 250, the heating fluid 220). The metal coil 140 is wrapped around the inner housing 210 (e.g., around a portion of the inner housing 210, around all of the inner housing 210 as shown in FIG. 3, etc.). As shown in FIG. 5, the metal coil 140 may be a double coil (e.g., the coil comprises two coils, e.g., a first metal coil and a second metal coil connected together side-by-side). The double coil may provide enhanced heat transfer (from the metal to the fuel).

As shown in FIG. 5, the metal coil 140 has a first end 141 and a second end 142. The first end 141 is fluidly connected to a first fuel line 440a via a first transition coupling 450a. The first fuel line 440a fluidly connects to the fuel tank of the vehicle 410. The second end 142 is fluidly connected to a second fuel line 440b via a second transition coupling 450b. The second fuel line 450b fluidly connects to the engine 430 of the vehicle 410. Fuel enters the metal coil 140 via the first end 141 and exits the metal coil 140 via the second end 142; fuel exiting the metal coil 140 is subsequently injected into the engine 430 of the vehicle 410. As shown in FIG. 1, the first fuel line 440a extends outwardly through the first end 111 (e.g., first plate 121) of the outer housing 110 and the second fuel line 440b extends outwardly through the second end 112 (e.g., second plate 122° of the outer housing 110.

The metal coil 140 may be constructed from a variety of materials and in a variety of sizes. For example, in some embodiments, the metal coil 140 is constructed from a material comprising copper. In some embodiments, the metal coil 140 has a diameter of about 2.25 inches. The metal coil is in no way limited to the aforementioned examples.

When the heating element 250 is activated, the temperature of the heating fluid 220 increases, which provides heat to and warms the external metal coil 140. The heat of the metal coil 140 then warms the fuel that runs through the metal coil 140. The heating fluid 220 helps transfer heat quickly (e.g., from the heating element 250 to the metal coil 140) and evenly distributes the heat in the inner housing 210. The heating fluid 220 helps to hold heat in the inner housing 210 (e.g., heat is held longer in the inner housing 210 with the heating fluid 220 than without the heating fluid 220).

In some embodiments, insulation 240 is disposed in the inner cavity 114 of the outer housing 110 surrounding the inner housing 210 and the metal coil 140.

The system 100 further comprises a first thermal disc 155a (e.g., first thermostat) for controlling fuel temperature. The first thermal disc 155a (e.g., first thermostat) is operatively connected to the metal coil 140. The first thermal disc 155a comprises a first sensor 150a that directly contacts the metal coil 140 (e.g., see FIG. 3). The first thermal disc 155a detects (via the first sensor 150a) the temperature of the metal coil 140 (e.g., the fuel). The direct connection between the first sensor 150a and the metal coil 140 may provide for a fast and accurate reading of the temperature of the metal coil 140 (and fuel). The first thermal disc 155a is adjustable and the system 100 comprises a means of controlling the first thermal disc 155a, allowing a user to control the temperature of the coil 140. Normally, the first thermal disc 155a is in a closed position; the first thermal disc 155a opens when activated (and the temperature rises). In some embodiments, the first thermal disc 155a has a temperature sensitivity from about 50° F. to about 249° F. (+/−5° F.), however the first thermal disc 155a is not limited to this temperature sensitivity.

In some embodiments, the first thermal disc 155a allows for the system 100 to be activated. For example, when activated (e.g., by the user or by detecting that the fuel is too cold according to pre-set values), the first thermal disc 155a may cause the heating element 250 to be activated. The fuel is warmed by the heating element 250 and fluid 220. When the fuel (e.g., coil 140) has reached a pre-set maximum temperature or target temperature or the fuel (e.g., coil 140) has reached a temperature within a range of a target temperature, the first thermal disc 155b opens, thereby deactivating the heating element 250. In some embodiments, when the heating element 250 is activated it heats to a particular temperature or temperature range and then is deactivated; the heating element 250 will then cool to a set differential and come back on if the fuel is still not to its set temperature. In some embodiments, the system 100 will repeat this cycle until the fuel reaches its target temperature (or temperature range). In some embodiments the system 100 continues to cycle in this manner in order to maintain the temperature of the fuel.

In some embodiments, the first thermal disc 155a helps to prevent overheating of the fuel. In some embodiments, the first thermal disc 155a helps to shut the system 100 off when the system 100 is not needed in order to conserve energy.

The system 100 further comprises a second thermal disc 155b (e.g., second thermostat) operatively connected to the metal coil 140 (e.g., the fuel). In contrast to the first thermal disc 155a, the second thermal disc 155b is not adjustable; the second thermal disc 155b functions as a safety device for preventing the system 100 from overheating. For example, the second thermal disc 155b may be programmed with a maximum temperature (e.g., 130° F., 125° F., 120° F., etc.). If the second thermal disc 155b detects the maximum temperature has been reached, the second thermal disc 155b causes the system 100 to shut off.

The heating element 250 is operatively connected to power source (e.g., the battery or fuses 450 of the vehicle 410), etc., e.g., via wires 290. The first thermal disc 155a is operatively connected to a power source (e.g., via wires 290). The second thermal disc 155b is operatively connected to a power source (e.g., via wires 290).

The system 100 of the present invention may be constructed in a variety of configurations. The descriptions below in no way limit the configuration of the system 100. For example, in some embodiments, a cover 110a is disposed on the outer housing 110, for example extending from the first end 111 to the second end 112 as shown in FIG. 1. The cover 110 may be removably attached to the outer housing 110 via a first attachment means 180a (e.g., screws, clasps, braces, bolts, etc.).

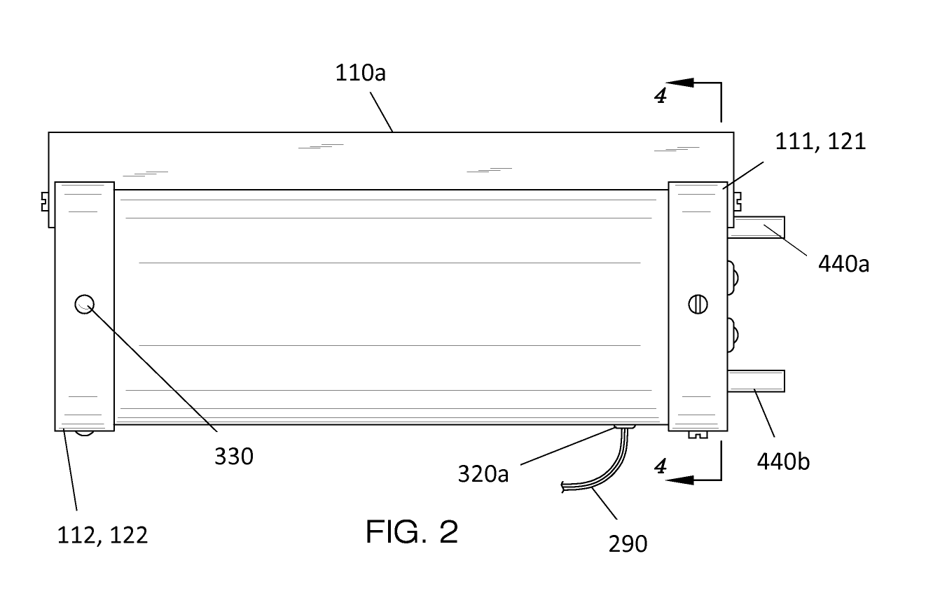

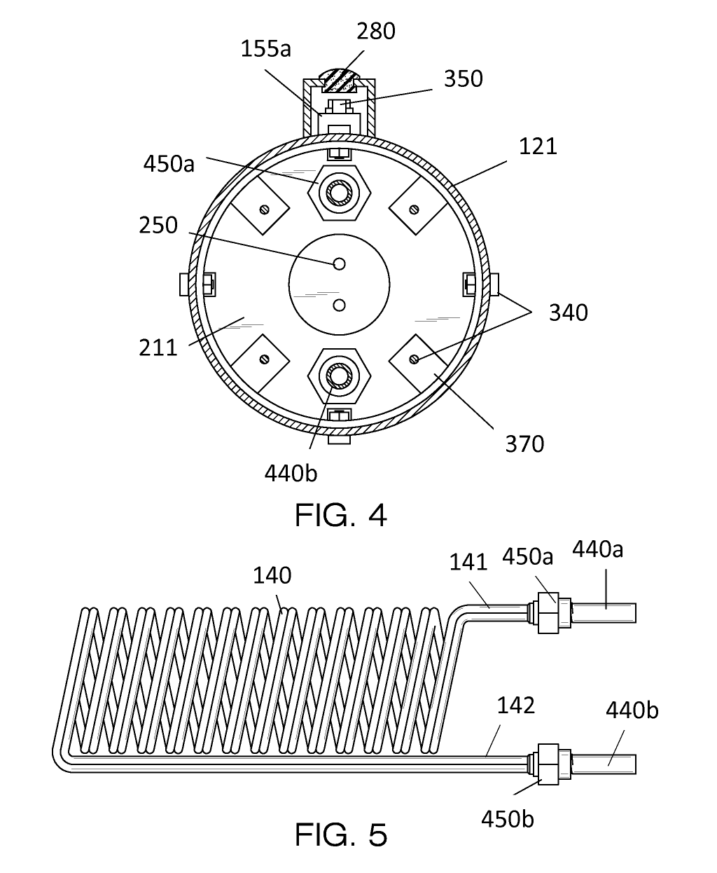

In some embodiments, the wires 290 exit the outer housing 110 via a first grommet 320a (e.g., see FIG. 2). In some embodiments, the wires 290 operatively connected to the second thermal disc 155b are fed out of the inner housing 210 and into the outer housing 110 (e.g., the cover 110a). In some embodiments, the wires connected to the first thermal disc 155a and the second thermal disc 155b are further fed from within the cover 110a into the outer housing 110 via a second grommet 320b (e.g., see FIG. 3). Components such as the cover 110a, the first thermal disc 155a, the second thermal disc 155b, the first plate 121, the second plate 122 etc., may be held within the system 100 via rivets 330, screws 340, adjustment screws 350, nuts 360, brackets 370, the like, or a combination thereof. In some embodiments, an access plug 380 is disposed in the cover 110a for providing access to the first thermal disc 155a (e.g., see FIG. 4).

In some embodiments, the system 100 further comprises one or more indicator lights 610. The indicator lights 610 may turn on and off, flash with various colors, or flash with various patterns for indicating the system 100 is on. Indicator lights are well known to one of ordinary skill in the art. The indicator lights 610 may be operatively connected to the first thermal disc 155a and/or the second thermal disc 155b. The indicator lights 610 are operatively connected to a power source, e.g., the indicator lights 610 are operatively connected to the negative side of each thermostat power source.

The fuel warming system 100 may be constructed in a variety of sizes. For example, in some embodiments, the outer housing 110 is about 12 inches in length as measured from the first end 111 to the second end 112. In some embodiments, the outer housing 110 is between about 6 to 12 inches in length as measured from the first end 111 to the second end 112. In some embodiments, the outer housing 110 is between about 12 to 18 inches in length as measured from the first end 111 to the second end 112. In some embodiments, the outer housing is more than about 18 inches in length.

In some embodiments, the housing 110 is about 4 inches in diameter. In some embodiments, the outer housing 110 is between about 2 to 4 inches in diameter. In some embodiments, the outer housing 110 is between about 4 to 6 inches in diameter. In some embodiments, the outer housing 110 is more than about 6 inches in diameter. The system 100 of the present invention is in no way limited to the aforementioned dimensions.

In some embodiments, the warming system 100 is installed in an aftermarket vehicle. In some embodiments, the warming system 100 is installed in a vehicle during production. In some embodiments, the fuel warming system 100 is mounted within the engine compartment of the vehicle 410.

In some embodiments, the fuel warming system 100 further comprises a remote control switch system for allowing a user to turn the fuel warming system 100 on and off from inside the vehicle 410. In some embodiments, the fuel warming device 100 may be activated at any time by the user so that fuel is delivered to the engine 430 at a predetermined temperature. In some embodiments, the fuel warming system 100 can be hooked up to an ignition system of the vehicle for activation.

As used herein, the term “about” refers to plus or minus 10% of the referenced number. For example, an embodiment wherein the outer housing 110 is about 5 inches in diameter includes an outer housing 110 that is between 4.5 and 5.5 inches in diameter.

The disclosures of the following U.S. Patents are incorporated in their entirety by reference herein: U.S. Pat. No. 4,700,047; U.S. Pat. No. 5,159,915; U.S. Pat. No. 5,378,358; U.S. Pat. No. 6,845,732; U.S. Pat. No. 6,743,355; U.S. Pat. No. 6,179,577; U.S. Pat. No. 4,865,005; U.S. Pat. No. 4,612,897.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

The reference numbers recited in the below claims are solely for ease of examination of this patent application, and are exemplary, and are not intended in any way to limit the scope of the claims to the particular features having the corresponding reference numbers in the drawings.

What is claimed is:

1. A fuel warming system 100 comprising:
(a) an outer housing 110 having a first end 111, a second end 112, and an inner cavity 114;
(b) an inner housing 210 disposed in the inner cavity 114 of the outer housing 110, the inner housing 210 having a first end 211, a second end 212, and an inner cavity 214, a heating fluid 220 fills the inner cavity 214 of the inner housing 210;
(c) a heating element 250 disposed in the inner cavity 214 of the inner housing 210, the heating element 250 functions to increase a temperature of the heating fluid 220;
(d) a metal coil 140 disposed in the inner cavity 114 of the outer housing 110 and coiled around the inner housing 210 and contacting the inner housing 210, the metal coil 140 has a first end fluidly connected to a first fuel line 440a and a second end 142 fluidly connected to a second fuel line 440b, wherein fuel enters the metal coil 140 via the first end 141 and exits the metal coil 140 via the second end 142, when the heating element 250 is activated heat transfers from the heating element 250 to the heating fluid 220 to the metal coil 140 to the fuel within the coil; and
(e) a first thermal disc 155a functioning to detect a temperature of the metal coil 140 via a first sensor 150a, the first sensor 150a directly contacts the metal coil 140, when the first thermal disc 155a is activated the first thermal disc 155a causes activation of the heating element 250 to a pre-set temperature, the pre-set temperature is adjustable.

2. The system 100 of claim 1 further comprising a second thermal disc 155b operatively connected to the metal coil 140, the second thermal disc 155h is programmed with a maximum temperature wherein if the second thermal disc 155b detects the maximum temperature, the second thermal disc 155b causes the system 100 to shut off.

3. The system 100 of claim 2, wherein the maximum temperature is about 130° F.

4. The system 100 of claim 2, wherein the maximum temperature is about 125° F.

5. The system 100 of claim 2, wherein the maximum temperature is about 120° F.

6. The system 100 of claim 1 further comprising insulation 240 disposed in the inner cavity 114 of the outer housing 110, the insulation 240 surrounds the inner housing 210 and the metal coil 140.

7. The system 100 of claim 1, wherein the first end 111 of the outer housing 110 is a removable first plate 121.

8. The system 100 of claim 1, wherein the second end 112 of the outer housing 110 is a removable second plate 122.

9. The system 100 of claim 1, wherein the outer housing 110 is generally cylindrical in shape.

10. The system 100 of claim 1, wherein the heating fluid 220 is an oil.

11. The system 100 of claim 1, wherein the heating element 250 extends from the first end 211 of the inner housing 210 to near the second end 212 of the inner housing 210.

12. The system 100 of claim 1, wherein the metal coil 140 is a double coil.

13. The system 100 of claim 1, wherein the metal coil 140 is constructed from a material comprising copper.

14. The system 100 of claim 1, wherein the first fuel line 440a extends outwardly through the first end 111 of the outer housing 110.

15. The system 100 of claim 1, wherein the first fuel line 440a extends outwardly through the second end 112 of the outer housing 110.

16. The system 100 of claim 1, wherein the second fuel line 440b extends outwardly through the first end 111 of the outer housing 110.

17. The system 100 of claim 1, wherein the second fuel line 440b extends outwardly through the second end 112 of the outer housing 110.
